(19) United States
(12) Patent Application Publication
(10) Pub. No.: US 2014/0379646 A1
(43) Pub. Date: Dec. 25, 2014

(54) Replication of Updates to DICOM Content

(71) Applicant: Lexmark International Technologies, S.A., Geneva (CH)

(72) Inventors: Jeffrey Allen Romotoski, Woodbury, MN (US); Ryan Timothy Sanford, South Saint Paul, MN (US)

(21) Appl. No.: 14/310,762

(22) Filed: Jun. 20, 2014

Related U.S. Application Data
(60) Provisional application No. 61/837,969, filed on Jun. 21, 2013.

(51) Int. Cl. G06F 17/30

(52) U.S. Cl. CPC G06F 17/30575
USPC 707/624

(57) ABSTRACT

A method of replicating a content update includes determining if metadata associated with the content update matches a previously registered metadata in a first system; if a match is identified, determining if the content update contains a metadata differing from a previously stored metadata in the first system; and if the content update is determined to contain a metadata differing from the previously stored metadata, replicating the content update to a second system.

### CROSS REFERENCES TO RELATED APPLICATIONS

The present application is related to and claims priority under 35 U.S.C. 119(e) from U.S. Provisional Patent Application Ser. No. 61/837,969, filed Jun. 21, 2013, entitled, “Replication of Updates to DICOM Content,” the contents of is which hereby incorporated by reference in its entirety. The present application is related to U.S. patent application Ser. No. 14/145,183, entitled, “Metadata Replication for Non-DICOM Content,” and U.S. patent application Ser. No. 14/145,206, entitled, “Multiple Subscriber Support for Metadata Replication,” both of which were filed on Dec. 31, 2013, and are assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates generally to methods for replicating objects in a network and, more specifically, to replicating updates to DICOM content.

2. Description of the Related Art

A computer network includes a variety of computing devices that communicate and share resources and data. Since networked devices in a medical environment is largely an architecture that relies on a stable network connection to share and access electronic health records from various healthcare enterprises, there is a risk for the networked system that is currently in use to be inaccessible due to system failures.

A partial system failure may occur when one or more, but not all, elements in the network operating the system are compromised. It can be caused by a software, hardware and/or network failure, which in turn causes a database management system (DBMS) server to be inaccessible for an unpredictable amount of time. A complete system failure may occur when a calamity, such as a fire, causes an entire system to be destroyed and rendered useless.

When a system failure occurs, networked devices, such as databases that contain information needed by healthcare enterprises, may become unavailable to users that need to store or retrieve data. The length of time it takes for the system to get back to an uptime condition and in a consistent state is unpredictable and the breakdown in functions and to operations may cause the loss of important documents and/or delays in the processing of valuable electronic medical records.

Accordingly, there is a need for a system and methods that provide a high availability solution for networks. There is also a need for methods to leverage various storage systems with replication services that allow high availability, wherein new content, as well as updates to previously stored content, that are stored and/or registered in a primary system are replicated to one or more secondary systems.

### SUMMARY

Methods of replicating updates to DICOM content are disclosed.

One example method of replicating a content update includes determining if metadata associated with the content update matches a previously registered metadata in a first system; if a match is identified, determining if the content update contains a metadata differing from a previously stored metadata in the first system; and if the content update is determined to contain a metadata differing from the previously stored metadata, replicating the content update to a second system.

One example method of metadata replication includes storing a content having metadata in a publisher device; determining if the metadata includes an update to a previously stored metadata in the publisher device; and if the metadata includes an update to the previously stored metadata, replicating the update to a subscriber device.

From the foregoing disclosure and the following detailed description of various example embodiments, it will be apparent to those skilled in the art that the present disclosure provides a significant advance in the art of methods for enabling network-based processes in a device during a network downtime condition. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood to by reference to the following description of example embodiments taken in conjunction with the accompanying drawings. Like reference numerals are used to indicate the same element throughout the specification.

FIG. 1 is a block diagram illustrating one example system for communication, storage and replication of content metadata.

FIG. 2 shows a method for replicating metadata of content from a publisher subsystem to multiple subscriber locations, according to one example embodiment.

FIG. 3 shows an example system performing an alternative example embodiment of metadata replication.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure to include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are methods and systems of replicating metadata associated with content in a networked environment. The methods provide a mechanism for leveraging storage systems with replication services for high availability of content and metadata within the network. The services take advantage of content and metadata replication features in to connected archive/storage architectures without the added overhead of multiple Digital Imaging and Communications in Medicine (DICOM) and/or non-DICOM storage. Replicating metadata may be performed using one publisher and multiple subscribers, wherein the publisher replicates content, metadata and updates to multiple subscribers in an enterprise.

For purposes of the present disclosure, it will be appreciated that the content may refer to files such as, for example, documents, image files, and audio files. Content may refer to paper-based records converted into digital files to be used by a computing device. Content may also refer to information that provides value for an end-user or content consumer in one or more specific contexts. Content may be shared via one or more media such as, for example, computing devices in a network.

In one example embodiment, content may refer to computerized medical records, or electronic medical records (EMR), created in a health organization, or any organization that delivers patient care such as, for example, a physician's office, a hospital, or ambulatory environments. EMR may include orders for drug prescriptions, orders for tests, patient admission information, imaging test results, laboratory results, and clinical progress information, among others.

Content may also refer to an electronic health record (EHR) which may be a digital content capable of being distributed, accessed or managed across various health care settings. EHRs may include various types of information such as, for example, medical history, demographics, immunization status, radiology images, medical allergies, personal states (e.g., age, weight, etc.), vital signs and billing information. EHR and EMR may also be referred to as an electronic patient record (EPR). The terms EHR, EPR, EMR, document, content and object may be used interchangeably for illustrative purposes throughout the present disclosure.

In another example embodiment, content may also refer to DICOM images. DICOM is a standard or specification for transmitting, storing, printing and handling information in medical imaging. Medical imaging, as is known in the art, may refer to a process and/or technique used to generate images of the human body, or parts or functions thereof, for medical and/or clinical purposes such as, for example, to diagnose, reveal or examine a disease. The standard set by DICOM may facilitate interoperability of various to medical imaging equipment across a domain of health enterprises by specifying and/or defining data structures, workflow, data dictionary, compression and workflow, among other things, for use in generating, transmitting and accessing the images and related information stored on the images. DICOM content may refer to medical images following the file format definition and network transmission protocol as defined by DICOM. DICOM content may include a range of biological imaging results and may include images generated through radiology and other radiological sciences, nuclear medicine, thermography, microscopy and medical photography, among many others. DICOM content may be referred to hereinafter as images following the DICOM standard, and non-DICOM content for other forms and types of content, as is known in the art.

Content may be generated and maintained within an institution such as, for example, an integrated delivery network, hospital, physician's office or clinic, to provide patients and health care providers, insurers or payers access to records of a patient across a number of facilities. Sharing of content may be performed using network-connected enterprise-wide information systems, and other similar information exchanges or networks, as is known in the art.

Metadata may refer to information regarding the content (e.g., DICOM and/or non-DICOM content). Metadata may provide information regarding the content such as, for example, information or data about a DICOM image including dimensions, size, modality used to create the data, bit depth, and settings of the medical imaging equipment used to capture the DICOM image. Non-DICOM content may also contain metadata that provides information related to the content. Non-DICOM content metadata may include information such as, for example, a list of a patient's medical history, demographics, immunization status, radiology images, medical allergies, basic patient information, (e.g., age, weight, etc.), vital signs and billing information. In an alternative example embodiment, non-DICOM content may include non-DICOM medical image data objects such as, for example, diagnostic objects having standard consumer object formats such as, JPEG, PDF, MPEG, TIFF, WAV, but may not be structured data objects (e.g. DICOM objects). Non-DICOM content may also be objects having no standard information model and wherein its data format does not specify required and/or standard identifying information that is associated with the content.

Content metadata may also refer to “content about content,” or “information about content,” that allows users to identify the content. Examples of content metadata may include to means of content creation, purposes of the content, time and date of content creation, creator of the content, author of the content, standards used in generating the content, origin of the content, and information regarding history of the content (e.g. modification history), among many others. Content metadata may be used to search, access, modify or delete content stored in a database. Metadata may be stored and managed in a database such as, for example, a metadata registry.

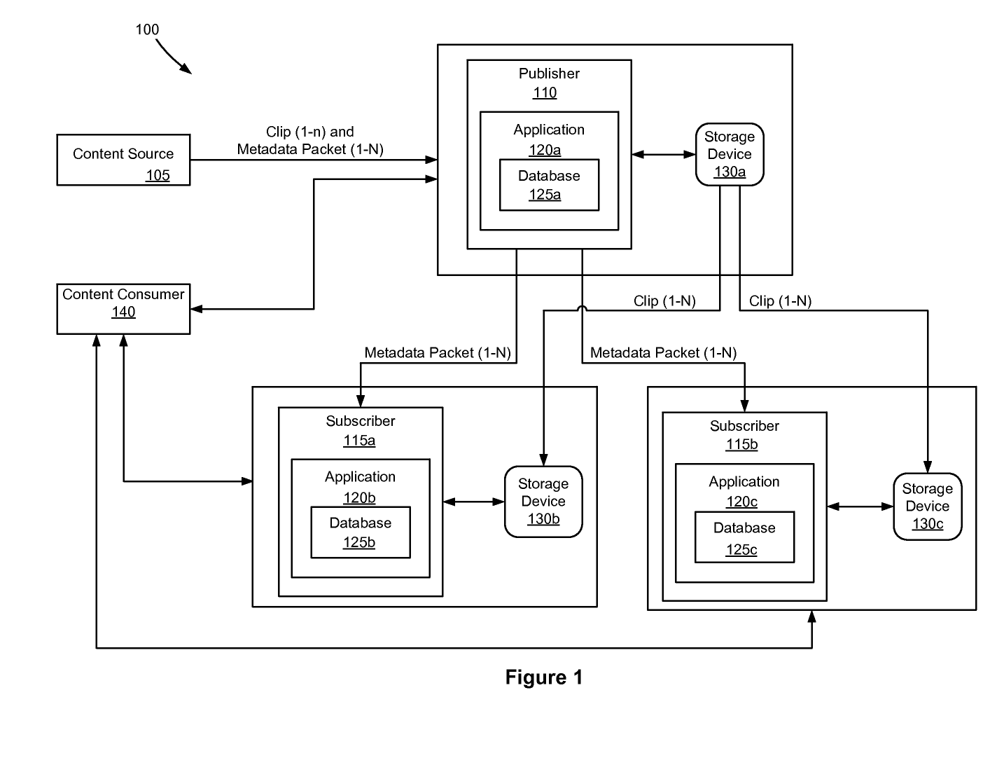

FIG. 1 is block diagram illustrating one example system 100 for communication, storage and replication of content metadata such as, for example, non-DICOM and DICOM content metadata. System 100 is used to perform a content and metadata replication feature for subsystems having a registry database and wherein each of the subsystems are connected to archive devices, as will be described herein.

In one example embodiment, the content and metadata replication feature provides subsystem-to-subsystem (e.g., publisher-to-subscriber) active-to-active viewing, querying and transferring abilities on distributed dynamic data using one or more technologies, such as, for example Microsoft Windows Communication Foundation (WCF) and Microsoft Distributed Transaction Coordinator (MSDTC) technologies. Other dynamic data distribution technologies may also be used to replicate metadata and content, as is known in the art.

In an alternative example embodiment, system 100 may be a Cross-Enterprise Document Sharing (XDS) system. XDS is a technical framework defined by Integrating Healthcare Environments (IHE) that facilitates the registration, distribution and access of patient electronic health records across healthcare enterprises. It provides a standards-based specification for managing the sharing of documents between any healthcare enterprises.

System 100 includes a content source 105, a publisher 110, and subscriber 115a and subscriber 115b. While only two subscribers are shown in the example embodiment illustrated, system 100 may include more than two subscribers.

System 100 is one example embodiment of a system having multiple subscriber support. Multiple subscriber support for a system may be provided by configuring database tables wherein a new table is created and multiple subscribers are assigned to a single publisher in the table. A Publisher-Subscriber configuration process may be performed by a to user of system 100, as will be discussed in greater detail below. With multiple subscriber support, publisher 110 may publish content and metadata to multiple subscribers such as a local subscriber and a remote subscriber. The relationship between publisher and subscribers is 1:N, with 1 publisher to N subscribers. Publisher 110 may be load balanced, as is known in the art.

Content source 105 refers to a producer of content that utilizes a computing device to create and submit content having associated metadata for storage and registration in publisher 110. In one example embodiment, content source 105 may be a computing device used to generate the content. In another example embodiment, content source 105 may be an organization that delivers care such as, for example, a physician's office or a hospital. Other examples of content sources include a desktop or laptop computer, a barcode scanner, a scanner, a copier, a tablet computer, or a mobile device, among many others.

Content source 105 may be an imaging content source. Imaging content sources may be imaging devices that generate imaging assets (e.g., medical images) that may be made available to one or more users of system 100 that query and/or retrieve content from a repository (not shown) of system 100. For example, imaging content sources may be medical imaging equipment such as MRI, X-Ray, ultrasound machines, mammography, CT scan and many others. When an imaging content source wishes to share a set of instances (e.g., medical images), it constructs a DICOM manifest that references the instances that are to be shared. The generated manifest and associated image-specific metadata may then be stored in a storage device such as, for example, storage devices 130a, 130b and 130c.

Content source 105 may perform at least one of the following: generation and submission of content and associated metadata to a repository; submission of content as an addendum to another content already present in the repository; submission of content as an alteration of another content already present in the repository such as, for example, updates to an already stored content (e.g., deletion or modification of the content); creation of a folder in the repository; and adding of one or more files or content to an existing folder in the repository.

Content source 105 may forward content, associated metadata, and/or updates to stored content to publisher 110. Publisher 110 may be a subsystem for receiving metadata and updates to metadata of previously stored content from content source 105 and publishing them to other subscriber subsystems, such as subscribers 115a and 115b.

After processing a request by content source 105 to store new or updated content and/or metadata, publisher 110 may update and replicate metadata to subscribers 115a and 115b. If publisher 110 is in a downtime condition, any one of subscribers 115a and 115b may take its place as the subsystem that processes requests from a client device.

Publisher 110 may be a subsystem that stores information that goes beyond standard clinical data collected in a single provider's office and, instead, stores data from multiple content sources or content providers. Publisher 110 may also be used to share information with one or more health care providers such as, for example, specialists and laboratories, and content stored in publisher 110 may be created and managed by authorized providers across more than one healthcare organization. In an alternative example embodiment, publisher 110 may be a device having one or more functionalities to perform the metadata replication feature as will be described below.

Subscribers 115a and 115b may be subsystems comprising one or more computing devices that are connected to each other by one or more communication links, as is known in the art. In an example embodiment, subscribers 115a and 115b may each be a passive subsystem comprising backup computing devices that may take the place of computing devices of publisher 110 if publisher 110 is unavailable for storing and/or retrieving data. In one example embodiment, subscribers 115a and 115b may be read-only subsystems that are not allowed to create and/or delete files. In an alternative example embodiment, subscribers 115a and 115b may be computing devices having one or more functionalities to perform the metadata replication feature in conjunction with publisher 110.

Each of publisher 110 and subscribers 115a and 115b also comprise one or more computing devices such as applications 120a, 120b, and 120c, and databases 125a, 125b and 125c. The computing devices are connected to each other in each subsystem by one or more communication links, as is known in the art.

Each of publisher 110 and subscribers 115a and 115b may include storage devices 130a, 130b and 130c, respectively. In an alternative example embodiment, storage devices 130a, 130b or 130c may not be part of publisher 110, subscriber 115a and subscriber 115b, to respectively, but are communicatively connected to each of publisher 110, and subscribers 115a and 115b, respectively, in communication links known in the art.

Application 120a in publisher 110 may be one or more software applications running on publisher 110 that receive replication tasks and perform one or more functions that allow publisher 110 to send information to subscribers 115a and 115b. Application 120a may perform a method that allows publisher 110 to send content and its associated metadata from database 125a and/or storage device 130a of publisher 110 over a network to at least one of databases 125b, 125c and/or storage devices 130b and 130c of subscribers 115a and 115b, respectively.

Applications 120b and 120c may be one or more software applications running on subscribers 115a and 115b which receive and store the transmitted information in their own computing devices. Applications 120b and 120c may perform a method that allows subscribers 115a and 115b, respectively, to receive information from publisher 110, such as a payload containing metadata, and replicate the metadata in databases 125b and 125c in subscribers 115a and 115b, respectively. Subscribers 115a and 115b may also receive content from publisher 110 and replicate the content in storage devices 130b and 130c connected to subscribers 115a and 115b, respectively.

Databases 125a, 125b and 125c are databases in publisher 110 and subscribers 115a and 115b, respectively, for registering and/or storing metadata associated with content created by content source 105 and stored in at least storage device 130a. Metadata storage may be performed in publisher 110 and subscribers 115a and 115b using databases 125a, 125b and 125c in order for content of interest (e.g., content used for the care of a patient) to be easily found, selected and retrieved from at least one of publisher 110 and subscribers 115a and 115b.

Metadata stored in databases 125a, 125b and 125c may be a collection of information received from content source 105 that allows an application such as, for example, a computer program, to quickly select desired metadata. Databases 125a, 125b and 125c may organize metadata using fields and records such as, for example, in an SQL database. In an alternative example embodiment, accessing metadata stored in publisher 110 and subscribers 115a and 115b may be performed using a database management system (DBMS), or any other collection of programs that enables a user to enter, organize, and select stored data.

Storage devices 130a, 130b and 130c are computer readable storage media for storing content from one of content source 105 and publisher 110, as applicable. Storage device 130a of publisher 110 may be a database for storing one or more content forwarded by content source 105 to publisher 110. In accordance with one example embodiment of the present disclosure, storage device 130a of publisher 110 may forward clips to at least one of storage devices 130b and 130c in subscribers 115a and 115b, respectively, during content replication between publisher 110 and subscribers 115a and 115b.

In one example embodiment, storage devices 130a, 130b and 130c may be content-addressable storage (CAS) devices. CAS devices refer to devices that store information that are retrievable based on the content of the information and not based on the information's storage location. CAS devices allow a relatively faster access to fixed content, or stored content that is not expected to be updated, by assigning the content a permanent location on the computer readable storage medium. CAS devices may make data access and retrieval up-front by storing the object such that the content cannot be modified or duplicated once it has been stored on the memory. In alternative example embodiments, storage devices 130a, 130b and 130c may be Grid, NAS, or other storage systems as is known in the art.

In one example embodiment, storage devices 130a, 130b and 130c may be referred herein as archive devices that are used by publisher 110 and subscribers 115a and 115b, respectively, in order to store or archive clip contents from content source 105. A clip may contain a set of related documents such as, for example, DICOM or non-DICOM documents.

Storage device 130a, application 120a and database 125a may be communicatively connected to each other to manage content during one or more processes such as, for example, searching and retrieving of stored content using the metadata, and updating stored content using the metadata. Metadata stored in database 125a and content stored in storage device 130a may be automatically replicated to at least one of databases 125b and 125c and storage devices 130b and 130c in subscribers 115a and 115b, respectively, and as will be discussed in greater detail below.

In an alternative example embodiment, system 100 may also include a load balancer (not shown) for scheduling transactions on multiple computing devices in order to to improve the over-all performance of system 100. The load balancer may be provided in system 100 by a dedicated software and/or hardware.

System 100 may also include a content consumer 140. In one example embodiment, publisher 110 may be an active system that processes client requests from content consumer 140 connected to publisher 110 and subscribers 115a and 115b.

Content consumer 140 may be a computing system that queries and/or retrieves content from databases such as, for example, storage device 130a connected to publisher 110. Content consumer 140 may generate query messages using metadata associated with the content and send the query messages to database 125a for retrieval of content that may be stored in storage device 130a, or in some cases, in storage devices 130b and 130c. In an alternative example embodiment, content consumer 140 may be a computing device that is used to query and/or retrieve content from any of the available repositories or storage devices connected to content consumer 140.

In another example embodiment, content consumer 140 may be an imaging document consumer. An imaging document consumer may query databases 125a, 125b and 125c of publisher 110 and subscribers 115a and 115b, respectively, for previously published and/or submitted images and retrieve the desired manifest document associated with the requested images. It may then decode the manifest and extract identifiers that uniquely identify the available images. Content consumer 140 may retrieve the images from an imaging document repository (e.g., storage device 130a). The images retrieved by content consumer 140 may be DICOM images.

While only one content consumer is shown in the example embodiment illustrated, system 100 may include two or more content consumers. Content consumers may be computing devices such as, but not limited to, a desktop or laptop computer, a barcode scanner, a scanner, a copier, a tablet computer or a mobile device.

The computing devices of content source 105, publisher 110, subscribers 115a and 115b and content consumer 140 may each include one or more processors communicatively coupled to a computer readable storage medium having computer executable program instructions which, when executed by the processor(s), cause the processor(s) to perform the steps described herein. The storage medium may include read-only memory (ROM), random access memory (RAM), non-volatile RAM (NVRAM), optical media, magnetic media, semiconductor memory devices, flash memory devices, mass data storage devices (e.g., a hard drive, CD-ROM and/or DVD units) and/or other memory as is known in the art. The processor(s) execute the program instructions to receive and send electronic medical images over a network. The processor(s) may include one or more general or special purpose microprocessors or any one or more processors of any kind of digital computer. Alternatives include those wherein all or a portion of the processor(s) is implemented by an application-specific integrated circuit (ASIC) or another dedicated hardware component as is known in the art.

Content source 105, publisher 110, subscribers 115a and 115b and content consumer 140 may be connected in a local area network (LAN) through one or more communication means in order to transmit and request content between each other. Other networks such as, WAN, wireless, among others, may also be utilized, as is known in the art, to connect the computing devices in system 100.

In one example embodiment, content source 105, publisher 110, subscribers 115a and 115b, and content consumer 140 may be communicatively connected to each other using Cross-Enterprise Document Reliable Interchange (XDR). XDR may provide a method for interchanging content, objects or instances using a point-to-point reliable messaging system. XDR allows direct interchange between healthcare image-capable systems. It will be appreciated that XDR provides a reliable and automatic transfer of content and metadata for one patient between content source 105, publisher 110, subscribers 115a and 115b, and content consumer 140.

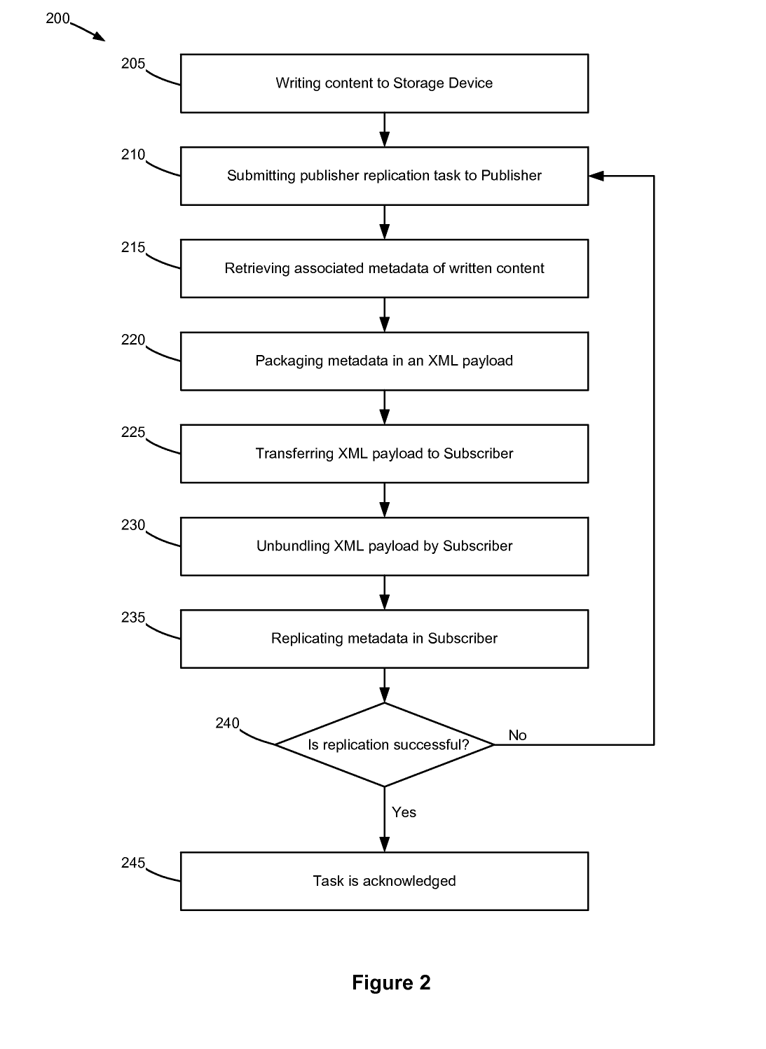

FIG. 2 shows a method 200 for replicating metadata of content from a publisher subsystem to multiple subscriber locations, according to one example embodiment. In this example, content source 105 is the source of the content having associated metadata to be stored in storage device 130a and the content and the associated metadata replicated to at least one of subscribers 115a and 115b.

Example method 200 may be a database replication process based on clip content written to storage device 130a. The replication is in sync with storage device 130a, wherein associated metadata is not replicated to at least one of subscribers 115a and 115b until content is written to storage device 130a.

In one example embodiment, method 200 illustrates a high availability feature for an XDS enterprise that provides capabilities for disaster recovery and business continuity. The high availability feature is performed on system 100 using a replication process that will be described in greater detail below. In one example embodiment, method 200 illustrates an XDS replication that is active/passive, wherein publisher 110 is active and/or writable such as, for example, when publisher 110 contains a read/write non-transitory computer readable medium that may be used to store content and associated metadata, and subscribers 115a and 115b are passive or read-only. Data stored in read-only memory such as in passive subsystems may not be modified. In some example embodiments, data stored in read-only may be modified but less efficiently as compared to active subsystems.

In an active/passive XDS replication, content source 105 may only store content and metadata to publisher 110 and not to subscribers 115a and 115b. Content consumer 140 may read information from both publishers 110 and subscribers 115a and 115b. During downtime conditions when content consumer 140 cannot communicate with publisher 110 to retrieve at least one of stored content and metadata, content consumer 140 may communicate with one of subscribers 115a and 115b to query content using the metadata. In alternative example embodiments, method 200 may be an active/active XDS replication process wherein both publisher 110 and subscribers 115a and 115b are writable.

At block 205, content may be received from content source 105 by publisher 110 and written to storage device 130a. Content, as aforementioned, may be a file or a document containing information and may include non-DICOM and/or DICOM content. Content may also contain metadata associated with the information included in the content. Metadata received from content source 105 by publisher 110 may be stored in database 125a. In alternative example embodiments, content and associated metadata received by publisher 110 may be stored in a repository (not shown) and registry (not shown), respectively. In yet other alternative example embodiments, the repository may refer to storage device 130a and the registry to database 125a. The repository and registry may be connected to publisher 110 or may comprise publisher 110.

For example, content source 105 may transmit non-DICOM content having metadata such as, for example, an image object having patient ID for its metadata. Content source 105 may generate the image object and send it to publisher 110 for storage of the image data in storage device 130a and the patient ID metadata in database 125a.

At block 210, a publisher replication task may be submitted to publisher 110. The publisher replication task may be created once the content is received from content source 105. A publisher replication task is a request automatically submitted to publisher 110 to replicate the metadata stored in database 125a to databases 125b and 125c of subscribers 115a and 115, respectively.

For example, when publisher 110 receives the image object and patient ID metadata from content source 105, the image object may be stored in storage device 130a and the patient ID metadata registered in database 125a. The storage and/or registration of the image object and metadata may then trigger a replication task to be submitted to publisher 110 in order to start a process of replicating metadata and content from publisher 110 to at least one of subscribers 115a and 115b.

At block 215, metadata is retrieved by publisher 110 from database 125a and the retrieved metadata is processed by packing the metadata in an Extensible Markup Language (XML) payload (at block 220). Processing the retrieved metadata may be performed by application 120a of publisher 110. Retrieving the metadata is performed after determining the content received and stored on storage device 130a.

Processing the retrieved metadata at block 220 may include bundling the metadata using XML in order to create an XML payload having the retrieved metadata. Creating an XML payload having the metadata may include annotating the metadata using standards and rules defined by the XML markup language. The XML payload packages the retrieved metadata to structure, store and transport the metadata from publisher 110 to subscribers 115a and 115b. In an alternative example embodiment, the XML payload may refer to data that is the cargo of a data transmission such as, for this example, the metadata that will be transmitted from publisher 110 to subscribers 115a and 115b.

The XML payload may be transmitted with information apart from the packaged metadata. This information may include a source database of the metadata to be replicated and added to the databases 125b and 125c of subscribers 115a and 115b as a replication source when the information is transmitted to subscribers 115a and 115b, as will be discussed below. Information that is to be transmitted together with the packaged metadata may be referred to herein as non-payload XML. Other data or information to be transmitted may include one or more target databases or databases to which metadata is to be replicated.

Other means of processing the retrieved metadata known in the art, which may or may not use another form of markup language, may be performed by application 120a in order to prepare the metadata for replication from publisher 110 to at least one of subscribers 115a and 115b.

At block 225, the XML payload and its accompanying data is transferred by publisher 110 to at least one of subscribers 115a and 115b, and when the metadata in an XML payload is received by at least one of applications 120b and 120c, the XML payload may be unbundled to extract the metadata from publisher 110 (at block 230). In one example embodiment, publisher 110 may specify a subscriber to which metadata will be sent. Specifying a subscriber may be performed by adding a Uniform Resource Locator (URL) of the subscriber to an interface in publisher 110 such as, for example, a publisher form interface (not shown).

Unbundling the XML payload may be performed by at least one of applications 120b and 120c of subscribers 115a and 115b, respectively. In an alternative example embodiment, unbundling the XML payload may refer to preparing the metadata for replication and may not be limited to extracting the metadata from an XML package.

In an alternative example embodiment, clip contents associated with the metadata may be transmitted from storage device 130a of publisher 110 to at least one of storage devices 130b and 130c of subscribers 115a and 115b, respectively.

At block 235, the metadata received from publisher 110 by subscribers 115a and 115b may be replicated in databases 125b and 125c, respectively. Replicating the metadata includes storing a copy of the received metadata into the databases. The replicated metadata may be used as a backup copy of the metadata in publisher 110, which may be used to provide an alternative copy of the metadata for retrieval by content consumer 140 when publisher 110 is in a downtime condition.

In an alternative example embodiment, subscribers 115a and 115b may specify a source of data to be replicated. The source may be found in a source database instance in the XML payload received from publisher 110. Subscribers 115a and 115b may add a database to source, wherein a subscriber can support multiple replicated publisher sources. Subscribers 115a and 115b may also update and delete specified replication sources.

In an alternative example embodiment, content received from publisher 110 may be replicated to one of storage devices 130b and 130c in subscribers 115a and 115b, respectively. Replicating the content includes storing a copy of the content to storage devices 130b and 130c to create backup copies of the content, allowing active retrieval of both content and associated metadata at subscriber locations. In an alternative example embodiment, when subscribers 115a and 115b receive the metadata, application 120b and 120c may rebuild database entries in databases 125b and 125c to include the content, making the content available at subscribers 115a and 115b. Content may move between storage devices 130a, 130b and 130c while metadata may move between databases 125a, 125b and 125c, as well as to other application nodes that may be available in each of publisher 110 and subscribers 115a and 115b.

At block 240, it is determined if replicating the metadata in at least one of databases 125b and 125c was successfully implemented. If the metadata replication task is successful, the task is acknowledged (at block 245) and an acknowledgement receipt may be transmitted to publisher 110 from the subscriber that has successfully replicated the metadata.

At block 240, if the metadata replication is unsuccessful, publisher 110 may receive a message from the subscriber on which the replication failed or where the replication task is rejected, and publisher 110 may handle re-execution of the replication process. The re-execution process may begin at block 210, wherein the XML payload containing the metadata is transmitted from publisher 110 to at least one of subscribers 115a and 115b. It will be understood that the re-execution process may begin on other blocks of method 200.

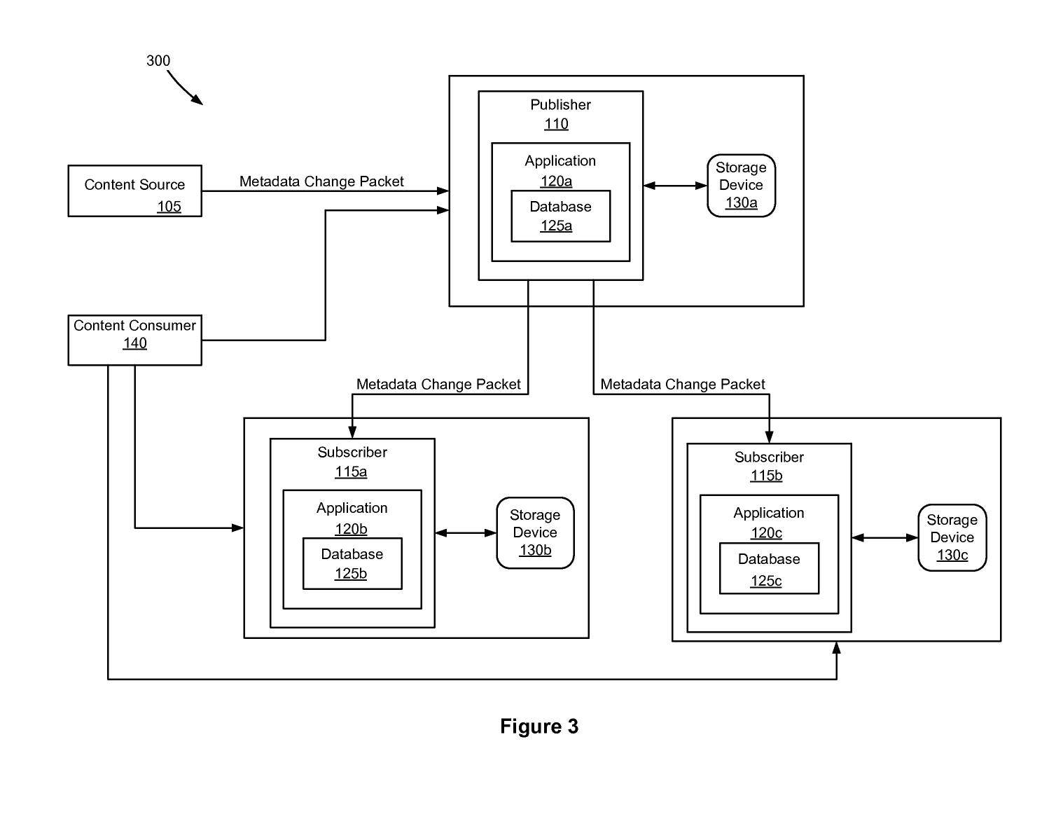

FIG. 3 shows example system 300 performing an alternative example embodiment of metadata replication. In this alternative example embodiment, publisher 110 may receive updates to the content associated with the metadata, instead of new content or metadata, from content source 105. Updates to the content may include changes in previously stored DICOM images, such as, for example, deletion of previously stored content, or updates in any information associated with the stored content or with any of the previously registered metadata. Publisher 110 may receive the updates and replicate the to updates to at least one of subscribers 115a and 115b using the blocks of example method 200.

In this alterative example embodiment, DICOM metadata for documents in a clip transferred from content source 105 to publisher 110 may change, but storage device 130a does not replicate the content such that no clip packet is exchanged between storage devices 130a, 130b and 130c as shown in example system 300 compared to clip packet exchanges shown in the example system of FIG. 1. Replicating updates to content may be performed similarly to replicating metadata discussed in example method 200, wherein updated metadata may be received from content source 105, and update metadata may be processed and packaged in an XML payload and transferred to at least one of subscribers 115a and 115b. The XML payload containing the updates to metadata may then be unbundled in subscribers 115a and 115b and replicated to corresponding databases in each of the subscriber subsystems connected to publisher 110. Successful replication of the metadata updates may be checked and acknowledged and if replication failed, transferring the XML payload may be re-performed, as discussed above.

For example, when content is deleted from storage device 130a, a delete task may be sent from publisher 110 to at least one of subscribers 115a and 115b in order to synchronize content and metadata between the subsystems in system 100. The delete task may be a header XML message that is built by application 120a in publisher 110 and sent to subscribers 115a and 115b. The delete task includes instructions to delete content in subscribers 115a and 115b that has been deleted in publisher 110. The metadata may be deleted using an application such as, for example, SQL server replication. Storage devices 130b and 130c may call a delete command which deletes content. Updates to content and metadata other than deletion may be performed.

Transmission of information between subsystems publisher 110 and subscribers 115a and 115b in system 100 that perform a process such as, for example, method 200, may utilize Representational State Transfer (REST), or RESTful web service. Replication of metadata including updates to the metadata from publisher 110 to at least one of subscribers 115a and 115b may be performed using RESTful web service.

REST is a software architecture that is used in various distributed systems such as, for example, the World Wide Web. It is a web API design model that is resource-oriented and uses basic design principles, such as being stateless, transferring XML, or JavaScript Object Notation (JSON), or both, explicitly using HTTP methods, and exposing directory to URIs. Metadata replication using RESTful web service is scalable in order to meet high performance demands.

It will be understood that the example applications described herein are illustrative and should not be considered limiting. It will be appreciated that the actions described and shown in the example flowcharts may be carried out or performed in any suitable order. It will also be appreciated that not all of the actions described in FIG. 2 need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of replicating a content update, comprising:
determining if metadata associated with the content update matches a previously registered metadata in a first system;
if a match is identified, determining if the content update contains a metadata differing from a previously stored metadata in the first system; and
if the content update is determined to contain a metadata differing from the previously stored metadata, replicating the content update to a second system.

2. The method of claim 1, wherein the metadata associated with the content update is a patient identifier.

3. The method of claim 1, wherein if the metadata associated with the content update fails to match a previously registered metadata, storing the content update in the first system and replicating the content update to the second system.

4. The method of claim 1, wherein the content update is a change to the previously stored metadata.

5. The method of claim 1, wherein the content update is a change to a previously stored metadata in the second system.

6. The method of claim 1, wherein the replicating the content update comprises deleting the previously stored metadata.

7. The method of claim 1, wherein the replicating the content update comprises deleting a previously stored metadata in the second system.

8. The method of claim 1, wherein the content update comprises a DICOM image.

9. The method of claim 8, wherein the content update to the previously stored content includes a change to the DICOM image.

10. The method of claim 8, further comprising replicating the changed DICOM image to the second system if a match is identified.

11. The method of claim 1, wherein the content update comprises a non-DICOM object.

12. A method of metadata replication, comprising:
storing a content having metadata in a publisher device;
determining if the metadata includes an update to a previously stored metadata in the publisher device; and
if the metadata includes an update to the previously stored metadata, replicating the update to a subscriber device.

13. The method of claim 12, further comprising replicating the content to the subscriber device if the update includes an update to a previously stored content.

14. The method of claim 12, wherein the subscriber device is one of a plurality of subscriber devices connected to the publisher device.

15. The method of claim 14, further comprising replicating the update metadata to each of the plurality of subscriber devices.

16. A computing device with a non-transitory computer-readable storage medium containing computer executable instructions to:
store a content having a metadata in a storage device;
determine if the metadata includes an update to a previously stored content;
if the metadata is determined to contain an update, replicate the update to a second computing device;
and
if the metadata is determined to be associated with a new content stored in the storage device, replicate the content to the second computing device.

17. The computing device of claim 16, wherein the content is a DICOM image object.

18. The computing device of claim 16, further comprising a computer instruction to package the update into a payload for replicating the update to the second computing device.

19. The computing device of claim 16, wherein the update includes a change to a metadata of the previously stored content.

20. The computing device of claim 16, wherein the update includes a change to at least one of a previously stored DICOM image and non-DICOM content.
